(19) United States
(12) Patent Application Publication
(10) Pub. No.: US 2006/0136995 A1
(43) Pub. Date: Jun. 22, 2006

(54) Computer system cluster data access authorization checking method and system

(76) Inventor: Chih-Wei Chen, Taipei (TW)

Correspondence Address: PEARL COHEN ZEDEK, LLP, 1500 BROADWAY 12TH FLOOR, NEW YORK, NY, 10036, US

(21) Appl. No.: 11/016,724

(22) Filed: Dec. 21, 2004

(51) Int. Cl. H04L 9/32

(52) U.S. Cl. 726/4

(57) ABSTRACT

A computer system cluster data access authorization checking method and system is proposed, which is designed for use in conjunction with an access control interface coupled between a data storage unit and a computer system cluster such as a server cluster for checking whether an access request from any one of the server units is authorized to gain access to the data storage unit, and which is characterized by the utilization of a access authorization database in the form of a linked list of main cells with bifurcated linked lists of branched cells for storing a set of access authorization data for the server cluster. This feature can help reduce the total number of comparisons in the access authorization database, thus enhancing the efficiency of the server cluster's overall access operations to the data storage unit.

### FIELD OF THE INVENTION

This invention relates to information technology (IT), and more particularly, to a computer system cluster data access authorization checking method and system, which is designed for use in conjunction with an access control interface coupled between a data storage unit (such as a RAID unit) and a computer system cluster having multiple independent computer units (such as a server cluster having multiple independent server units), for providing the multiple server units with a data access authorization checking procedure that checks whether an access command from any one of the server units is authorized to gain access to the data storage unit.

### BACKGROUND OF THE INVENTION

RAID (Redundant Array of Independent Disks) is a multi-disk storage unit that contains two or more hard disks, and which is commonly connected to one or more network servers to offer a very large data storage capacity. In practical application, the storage space of a RAID unit is typically partitioned into a number of volumes which can be respectively assigned to the multiple server units in a server cluster to server as logical units.

In actual application of a server cluster, it is often required to set authorization status to each server unit so that some server units are authorized to gain access to the RAID unit and others are unauthorized, and each authorized server unit is only allowed to gain access to certain specified volumes in the RAID unit. For this sake, the access control interface coupled between a RAID unit and a server cluster is required to be preinstalled with an access authorization database for storing the codenames of authorized server units and the mapping relationships of logical units to volumes so as to allow the access control interface to determine whether an access command is an authorized one and which volume is to be accessed.

FIG. 1 shows an access authorization database in the form of a table that is utilized by a conventional access control interface for storing a set of access authorization data for a cluster of server units. As shown, this access authorization database is based on a table containing a rectangular array of storage cells for defining a set of access authorization data for a cluster of 7 server units which are respectively designated with the following codenames: SERVER(1), SERVER(2), SERVER(3), SERVER(4), SERVER(5), SERVER(6), SERVER(7), wherein it is assumed that SERVER(1), SERVER(2), SERVER(5), SERVER(6), and SERVER(7) are authorized server units while SERVER(3) and SERVER(4) are unauthorized ones.

The table shown in FIG. 1 indicates that the server unit SERVER(1) has 3 logical units LUN0, LUN1, LUN3 which are mapped to the volumes VOLUME_2, VOLUME_0, VOLUME_4; the server unit SERVER(2) has 2 logical units LUN0, LUN2 which are mapped to the volumes VOLUME_1, VOLUME_7; the server unit SERVER(5) has only one logical units LUN0 which is mapped to the volume VOLUME_5; the server unit SERVER(6) has 2 logical units LUN0, LUN1 which are mapped to the volumes VOLUME_6, VOLUME_3; and the server unit SERVER(7) has only one logical unit LUN0 which is mapped to the volume VOLUME_8.

In the event that the authorized server unit SERVER(2) issues an access command requesting that it wants to gain access to its logical unit LUN2 corresponding to the volume VOLUME_7, the codename SERVER(2) in the access command will be compared sequentially from top to down against each of the data items stored in the first column in the table of FIG. 1. When compared to the second storage cell in the first column, the content “SERVER(2)” is matched, but since the associated logical unit LUN0 is unmatched, the authorization checking process continues to the next storage cells. When compared to the 7th storage cell in the first column, the content “SERVER(2)” is matched and the associated logical unit “LUN0” is also matched, then it is concluded that the server unit SEVER(2) is authorized, and the requested volume VOLUME_7 corresponding to the requested logical unit LUN0 is found. The access command is then authorized to gain access to the volume VOLUME_7.

On the other hand, in the event that the unauthorized server unit SERVER(3) issues an access command, the authorization checking process will compare the codename SERVER(2) sequentially from top to down with each of the data items stored in the first column of the table of FIG. 1. Since the codename SERVER(2) is not stored in the table, it will require the authorization checking process to perform a total of 9 comparisons to conclude that the server unit SERVER(3) is unauthorized.

One apparent drawback to the foregoing authorization checking method is that if an access command is issued from an unauthorized server unit, it will require the authorization checking process to compare the codename against everyone of the storage cells in the first column, i.e., in the case of SERVER(3), it will require the authorization checking process to perform a total of 9 comparisons to conclude that the server unit SERVER(3) is unauthorized. This lengthy authorization checking process would undoubtedly keep other access commands from other server units in waiting state for a long time and thus slow down the server cluster's overall access operations to the RAID unit. The conventional access authorization checking method is therefore quite inefficient.

### SUMMARY OF THE INVENTION

It is therefore an objective of this invention to provide a computer system cluster data access authorization checking method and system which can help reduce the total number of comparisons in the access authorization database for enhancing the efficiency of a server cluster's overall access operations to a data storage unit.

The computer system cluster data access authorization checking method and system according to the invention is designed for use in conjunction with an access control interface coupled between a data storage unit (such as a RAID unit) and a computer system cluster having multiple independent computer units (such as a server cluster having multiple independent server units), for providing the multiple server units with a data access authorization checking procedure that checks whether an access command from any one of the server units is authorized to gain access to the data storage unit.

The computer system cluster data access authorization checking method and system according to the invention is characterized by the utilization of a linked list of main cells with bifurcated linked lists of branched cells rather than a table of rectangular array of cells for storing a set of access authorization data for a cluster of server units. This feature can help reduce the total number of comparisons in the access authorization database, thus enhancing the efficiency of the server cluster's overall access operations to the data storage unit.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an example of the data structure of an access authorization database in the form of a table utilized by a conventional access authorization checking method;

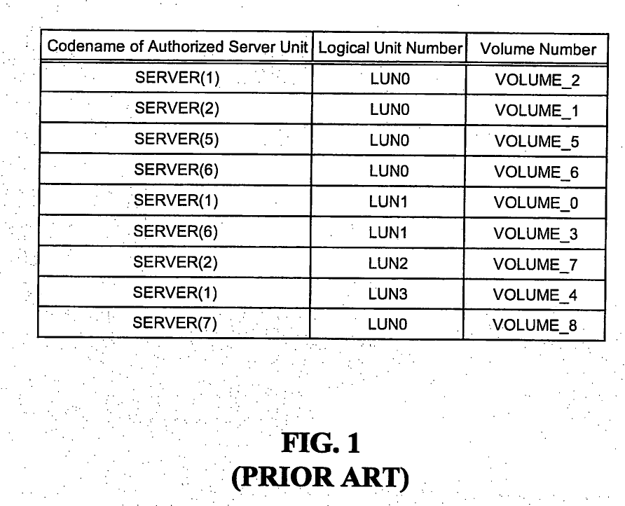

FIG. 2 is a schematic diagram showing the application architecture and object-oriented component model of the computer system cluster data access authorization checking system according to the invention; and

FIG. 3 is a schematic diagram showing an example of the data structure of an access authorization database in the form of linked list utilized by the computer system cluster data access authorization checking system according to the invention.

### DETAILED DESCRIPTION OF PREFERRED EMBODIMENTS

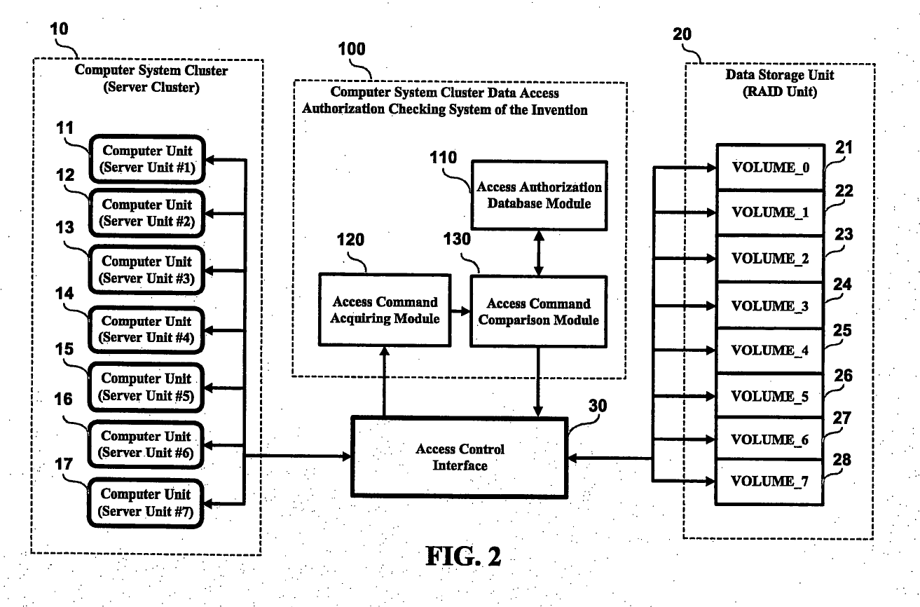

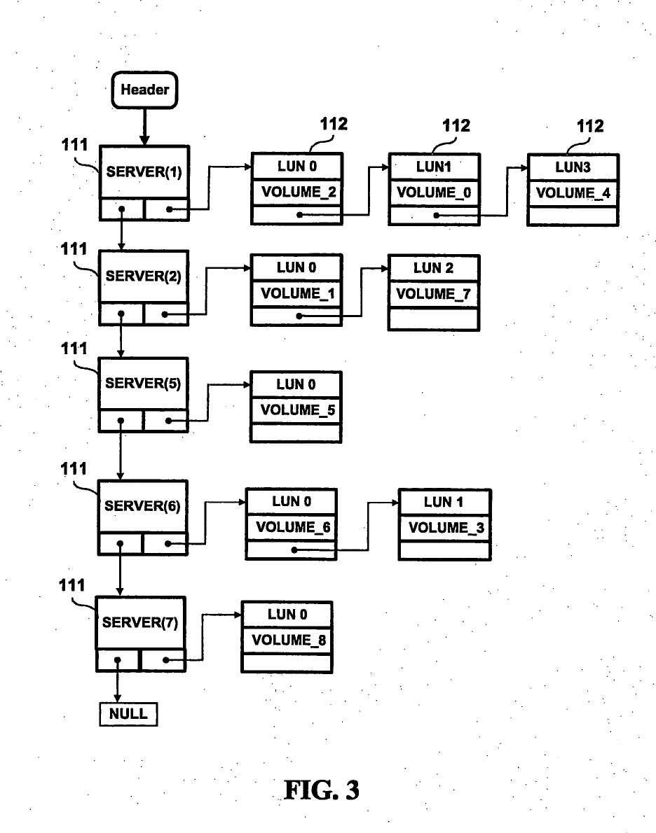

The computer system cluster data access authorization checking method and system according to the invention is disclosed in full details by way of preferred embodiments in the following with reference to FIG. 2 and FIG. 3.

FIG. 2 is a schematic diagram showing the system architecture of the computer system cluster data access authorization checking system according to the invention (as the part enclosed in the dotted box indicated by the reference numeral 100). As shown, the computer system cluster data access authorization checking system of the invention 100 is designed for use in conjunction with an access control interface 30 that is coupled between a data storage unit (such as a RAID unit) and a computer system cluster having multiple independent computer units (such as a server cluster 10 having multiple independent server units, for example 7 independent server units 11, 12, 13, 14, 15, 16, 17 in the example of FIG. 2) and. In the embodiment of FIG. 2, for example, the server cluster 10 includes only 7 server units 11, 12, 13, 14, 15, 16, 17 for demonstrative purpose only, but in practice, the number of server units is unlimited. These server units 11, 12, 13, 14, 15, 16, 17 are for example respectively designated with the following codenames: SERVER(1), SERVER(2), SERVER(3), SERVER(4), SERVER(5), SERVER(6), SERVER(7). The storage space of the data storage unit 20 is divided into a number of volumes, for example 8 volumes which are respectively named VOLUME_0, VOLUME_1, VOLUME_2, VOLUME_3, VOLUME_4, VOLUME_5, VOLUME_6, VOLUME_7 and labeled with the reference numerals 21, 22, 23, 24, 25, 26, 27, 28. In practical implementation, for example, the access control interface 30 can be either an FC (Fibre Channel) compliant or an iSCSI (Internet SCSI, where SCSI=Small Computer System Interface) compliant interface.

Functionally, the computer system cluster data access authorization checking system of the invention 100 is capable of performing a data access authorization checking procedure for each access command issued by any one of the server units 11, 12, 13, 14, 15, 16, 17 in the server cluster 10 to the data storage unit 20, for checking whether the associated server unit (11, 12, 13, 14, 15, 16, or 17) of each received access command is authorized to gain access to the data storage unit 20. If unauthorized, an access-inhibiting message will be issued to the access control interface 30; and whereas if authorized, an access-enabling message will be issued to the access control interface 30 to command the access control interface 30 to perform an access operation on the requested volume (i.e., 21, 22, 23, 24, 25, 26, 27, or 28) for the authorized server unit.

In the following example, it is assumed that the server cluster 10 includes 5 authorized server units whose codenames are SERVER(1), SERVER(2), SERVER(5), SERVER(6), SERVER(7), and 2 unauthorized server units whose codenames are SERVER(3) and SERVER(4).

As shown in FIG. 2, the object-oriented component model of the computer system cluster data access authorization checking system of the invention 100 comprises: (a) an access authorization database module 110; (b) an access command acquiring module 120; and (c) an access command comparison module 130.

The access authorization database module 110 is used to store an access authorization database as that shown in FIG. 3 in the form of linked lists including a linked list of main cells 111 with each main cell 111 being bifurcated to an associated list of branch cells 112, where the main cells 111 are used to store the respective codenames of all the authorized server units in the server cluster 10 in a sequentially-sorted order of the codenames, while the branch cells 112 associated with each main cell 111 are used to store the mapping relationships of each logical unit of the associated server unit to its corresponding volume in the data storage unit 20. For example, if the server cluster 10 includes 5 authorized server units 11, 12, 15, 16, 17 whose codenames are SERVER(1), SERVER(2), SERVER(5), SERVER(6), SERVER(7), and 2 unauthorized server units 13, 14 whose codenames are SERVER(3) and SERVER(4), then the codenames SERVER(1), SERVER(2), SERVER(5), SERVER(6), SERVER(7) of the authorized server units 11, 12, 15, 16, 17 are stored in sequentially-sorted order from the smallest to the largest in the linked list of the main cells 11, with the associated mapping relationships of logical units to volumes being stored in the bifurcated linked list of branch cells 112.

The access command acquiring module 120 is coupled to the access control interface 30, and which is capable of acquiring each access command received by the access control interface 30 from the server units 11, 12, 13, 14, 15, 16, 17 in the server cluster 10, and then transferring each acquired access command to the access command comparison module 130.

The access command comparison module 130 is capable of comparing the codename contained in each access command acquired by the access command acquiring module 120 sequentially against each of the data item stored in the linked list of main cells 111 in the access authorization database module 110. If the codename is matched to a certain main cell 111, the access command comparison module 130 then compares the logical unit number contained in the access command sequentially against each data item stored in the bifurcated linked list of branch cells 112 to find the corresponding volume in the data storage unit 20, and then issues an access-enabling message to the access control interface 30; whereas if no match is found, the access command comparison module issues an access-inhibiting message to the access control interface 30.

In the following description of a practical example of the application of the invention, it is assumed that the server cluster 10 includes 5 authorized server units whose codenames are SERVER(1), SERVER(2), SERVER(5), SERVER(6), SERVER(7), and 2 unauthorized server units whose codenames are SERVER(3) and SERVER(4).

In the event that the authorized server unit 12, whose codename is SERVER(2), wants to gain access to its logical unit LUN2 (i.e., the volume VOLUME_7 in the data storage unit 20), the server unit 12 issues a corresponding access command to the access control interface 30. When this access command is received by the access control interface 30, it will be acquired by the access command acquiring module 120 and then sent to the access command comparison module 130, where the codename SERVER(2) in the access command is compared from the header of the linked list of main cells 111, i.e., first against the first main cell 111 in the access authorization database module 110 to see if the content of the first main cell 111 is matched. Since the content of the first main cell 111 is “SERVER(1)”, which is unmatched, the authorization checking process jumps to the next-linked main cell 111. Since the content of the second main cell 111 is “SERVER(2)”, which is matched, the authorization checking process then jumps to the bifurcated list of branch cells 112 to find the volume corresponding to the logical unit LUN2. Since the content of the first branch cell 112 associated with SERVER(2) is LUN0, which is unmatched, the authorization checking process jumps to the next-linked branch cells 112. Since the content of the second branch cell 112 is LUN2, which is matched, the corresponding volume parameter “VOLUME_{—}7” is retrieved. Next, the access command comparison module 130 issues an access-enabling message to the access control interface 30, commanding the access control interface 30 to link the authorized server unit 12 to the requested volume VOLUME_7 in the data storage unit 20 to thereby allow the authorized server unit 12 to gain access to the volume VOLUME_7 in the data storage unit 20.

On the other hand, in the event that the unauthorized server unit 13, whose codename is SERVER(3), issues an access command to the access control interface 30, then when the access control interface 30 receives this access command, the access command acquiring module 120 will acquire this access command from the access control interface 30 and then send it to the access command comparison module 130, where the codename SERVER(3) in the access command is compared first against the content of the first main cell 111 in the access authorization database module 110. Since the content of the first main cell 111 is “SERVER(1)”, which is unmatched and the number (1) is smaller than (3), the authorization checking process jumps to the next-linked second main cell 111. Since the content of the second main cell 111 is “SERVER(2)”, which is also unmatched and the number (2) is smaller than (3), the authorization checking process jumps to the next-linked third main cells 111. Since the content of the third main cells 111 is “SERVER(5), which is also unmatched but the number (5) is greater than (3), it can be determined at this point that the codename “SERVER(3)” is unauthorized (i.e., not stored in the access authorization database module 110) so that the associated server unit 13 is unauthorized to gain access to the data storage unit 20. Consequently, the access command comparison module 130 will issue an access-inhibiting message to the access control interface 30 to thereby inhibit the unauthorized server unit 13 from gaining access to the data storage unit 20.

Compared to the prior art, it can be seen from the foregoing example that the access command comparison module 130 needs just to perform 3 comparisons to conclude that the server codename SERVER(3) is unauthorized; and by contrast, the prior art needs to perform 9 comparisons. Therefore, it is clear that the invention can help reduce the total number of comparisons in the access authorization database, thus shortening the waiting time by other server units and effectively enhancing the efficiency of the server cluster's overall access operations to the data storage unit.

In conclusion, the invention provides a computer system cluster data access authorization checking method and system for use in conjunction with an access control interface coupled between a data storage unit and a cluster of computer: units for providing a data access authorization checking procedure that checks whether an access request from any one of the computer units is authorized to gain access to the data storage unit, and which is characterized by the utilization of a linked list of main cells with bifurcated linked lists of branched cells rather than a table of rectangular array of cells for storing a set of access authorization data for a cluster of server units. This feature can help reduce the total number of comparisons in the access authorization database, thus enhancing the efficiency of the server cluster's overall access operations to the data storage unit. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer system cluster data access authorization checking method for use on an access control interface coupled between a data storage unit and a computer system cluster having multiple computer units for providing a data access authorization checking procedure for checking whether an access command received by the access control interface from one of the computer units in the computer system cluster is authorized to gain access to the data storage unit;
the computer system cluster data access authorization checking method comprising:
building an access authorization database in the form of a linked list of main cells with each main cell being bifurcated to an associated linked list of branch cells, where the main cells are each used to store a codename that represents each authorized computer unit in the computer system cluster in a sequenced order, and the branch cells associated with each main cell are used to store the mapping relationships of logical units of the associated computer unit to authorized volumes in the data storage unit; and
in actual operation when an access command is received by the access control interface,
acquiring the access command received by the access control interface;
comparing a codename contained in the access command sequentially against the data stored in the linked list of main cells;
if no match is found, issuing an access-inhibiting message to the access control interface; and
if the codename in the access command is matched to a certain main cell, then
comparing a logical unit number contained in the access command against the data stored in the bifurcated linked list of branch cells to find the corresponding volume in the data storage unit; and
issuing an access-enabling message to the access control interface.

2. The computer system cluster data access authorization checking method of claim 1, wherein the computer system cluster is a server cluster, and each computer unit in the computer system cluster is a server unit.

3. The computer system cluster data access authorization checking method of claim 1, wherein the data storage unit is a RAID (Redundant Array of Independent Disks) unit.

4. The computer system cluster data access authorization checking method of claim 1, wherein the access control interface is an FC (Fibre Channel) compliant interface.

5. The computer system cluster data access authorization checking method of claim 1, wherein the access control interface is an iSCSI (Internet Small Computer System Interface) compliant interface.

6. A computer system cluster data access authorization checking system for use with an access control interface coupled between a data storage unit and a computer system cluster having multiple computer units for providing a data access authorization checking procedure for checking whether an access command received by the access control interface from one of the computer units in the computer system cluster is authorized to gain access to the data storage unit;
the computer system cluster data access authorization checking system comprising:
an access authorization database module, which is used to store a access authorization database in the form of a linked list of main cells with each main cell being bifurcated to an associated linked list of branch cells, where the main cells are each used to store a codename that represents each authorized computer unit in the computer system cluster in a sequenced order, and the branch cells associated with each main cell are used to store the mapping relationships of logical units of the associated computer unit to authorized volumes in the data storage unit;
an access command acquiring module, which is capable of acquiring each access command received by the access control interface from any one of the computer units in the computer system cluster, wherein each access command contains a codename that represents the computer unit that issues the access command and a logical unit number that represents the logical unit of the computer unit where data is to be accessed;
an access command comparison module, which is capable of comparing the codename contained in the access command acquired by the access command acquiring module sequentially against the data stored in the linked list of main cells;
if the codename in the access command is matched to a certain main cell, the access command comparison module then compares the logical unit number contained in the access command against the data stored in the bifurcated linked list of branch cells to find the corresponding volume in the data storage unit, and then issues an access-enabling message to the access control interface; and
if no match is found, the access command comparison module issues an access-inhibiting message to the access control interface.

7. The computer system cluster data access authorization checking system of claim 6, wherein the computer system cluster is a server cluster, and each computer unit in the computer system cluster is a server unit.

8. The computer system cluster data access authorization checking system of claim 6, wherein the data storage unit is a RAID (Redundant Array of independent Disks) unit.

9. The computer system cluster data access authorization checking system of claim 6, wherein the access control interface is an FC (Fibre Channel) compliant interface.

10. The computer system cluster data access authorization checking system of claim 6, wherein the access control interface is an iSCSI (Internet Small Computer System Interface) compliant interface.
